(19) United States
(12) Patent Application Publication
(10) Pub. No.: US 2011/0305029 A1
(43) Pub. Date: Dec. 15, 2011

(54) Illuminating system and thin plate shield illuminating apparatus

(75) Inventors: Yu-Jen Chuang, Kaohsiung City (TW); Chang-Yuan Ju, Taichung City (TW)

(73) Assignee: United Radiant Technology Corporation, Taichung (TW)

(21) Appl. No.: 13/134,690

(22) Filed: Jun. 14, 2011

(30) Foreign Application Priority Data
Jun. 15, 2010 (TW) 099119437

(51) Int. Cl. B60Q 1/08; B60Q 1/00; F21V 29/00; F21V 7/00

(52) U.S. Cl. 362/464; 362/296.01; 362/459; 362/297; 362/294

(57) ABSTRACT

An illuminating system having an electronic shield illuminating apparatus comprises a semiconductor light-emitting source, a reflector, an electronic shield, a shield driving control circuit, and a projection lens. The reflector is intended for reflecting a portion of the light reflected by the semiconductor light-emitting source, and has a reflecting surface facing the semiconductor light-emitting source. The electronic shield is intended for generating different shield patterns to mask the light emitted by the semiconductor light-emitting source, and the light reflected by the reflector, and has a main surface facing the semiconductor light-emitting source and the reflecting surface of the reflector. The shield driving control circuit drives the electronic shield to generate different shield patterns in response to a signal information. The projection lens projects the light passing through the electronic shield.

### FIELD OF THE INVENTION

The present invention relates to an illuminating system and a thin plate shield illuminating apparatus, in particular an illuminating system and a thin plate shield illuminating apparatus for a projection-type vehicle headlight.

### BACKGROUND OF THE INVENTION

FIG. 1 shows a conventional vehicle headlight 900. The vehicle headlight 900 turns along with the running direction of the vehicle, thereby changing the illuminating direction. As shown in FIG. 1, the vehicle headlight 900 is initially heading straight (as illustrated in solid lines). When the vehicle turns right, the vehicle headlight 900 also turns right (as illustrated in dotted lines) accordingly, which in turn results in the turning right of the projected light pattern (as shown in hatching), thereby changing the illuminating direction.

However, the conventional vehicle headlight 900 needs a vast number of mechanical and electrical components to fulfill the object of changing the illuminating direction. This results in the bulk of the vehicle headlight 900 as it comprises a vast number of components, and is thus not cost-effective.

Moreover, the turning of the vehicle headlight normally takes a long time to response.

### SUMMARY OF THE INVENTION

In view of the problems outlined above, it is the object of the present invention to provide a compact illuminating system which is constructed of fewer components and is faster in reaction.

An illuminating system has an electronic shield illuminating apparatus comprising: a semiconductor light-emitting source; a reflector for reflecting a portion of the light emitted from the semiconductor light-emitting source, the reflector having a reflecting surface facing the semiconductor light-emitting source; an electronic shield for generating different shield patterns for masking the light emitted by the semiconductor light-emitting source and the light reflected by the reflector, the electronic shield having a main surface facing the semiconductor light-emitting source and the reflecting surface of the reflector; a shield driving control circuit for driving the electronic shield to generate different shield patterns in response to a signal information; and a projection lens for projecting the light passing through the electronic shield.

Another object of the present invention is to provide a thin plate shield illuminating apparatus. The thin plate shield illuminating apparatus comprises a semiconductor light-emitting source disposed to project the light downwardly; a reflector for reflecting a portion of light emitted by the semiconductor light-emitting source, the reflector having a reflecting surface facing the semiconductor light-emitting source and facing upwards; a thin plate shield including a reflecting surface impermeable to light for reflecting the light emitted by the semiconductor light-emitting source and the light reflected by the reflector; and a projection lens projecting the light reflected by the thin plate shield and a portion of light emitted by the semiconductor light-emitting source.

The advantage of the present invention resides in that it can attain the effect of turning the projected light pattern by simply using the shield driving control circuit to change the shield pattern generated by the electronic shield without having to swivel or rotate the illuminating system.

### BRIEF DESCRIPTION OF THE DRAWINGS

FIG. 1 is a schematic drawing showing the turning status of a conventional vehicle headlight;

FIG. 2 is a perspective view of an illuminating system according to a preferred embodiment of the present invention;

FIG. 3 is a schematic drawing showing an electronic shield illuminating apparatus;

FIG. 4a is a schematic diagram showing the shield pattern generated by the electronic shield during the normal running mode (travel linearly) of the vehicle;

FIG. 4b is a schematic diagram showing the light pattern projected by the electronic shield illuminating apparatus during the normal running mode (travel linearly) of the vehicle;

FIG. 5a shows the shield pattern generated by the electronic shield when the vehicle turns right;

FIG. 5b shows the light pattern generated by the electronic shield illuminating apparatus when the vehicle turns right;

FIG. 6a shows the shield pattern generated by the electronic shield when the vehicle turns left;

FIG. 6b shows the light pattern generated by the electronic shield illuminating apparatus when the vehicle turns left;

FIG. 7 is a side view of the electronic shield illuminating apparatus (with the shield driving control circuit omitted for clarity, and the directions of the arrows indicating the travel paths of the light beams);

FIG. 8 is a schematic drawing showing the structure of a thin plate shield illuminating apparatus; and

FIG. 9 is a side view of the thin plate shield illuminating apparatus (the arrows indicating the travel paths of the light beams).

### DETAILED DESCRIPTION OF THE PREFERRED EMBODIMENTS

Exemplary embodiments of the present invention are explained in detail below with reference to the accompanying drawings.

FIG. 2 is a perspective view of an illuminating system 1 according to a preferred embodiment of the present invention. In the present embodiment, an illuminating system 1 comprises, but not limited to, a projection vehicle headlight. The illuminating system 1 comprises at least an electronic shield illuminating apparatus 2, at least a thin plate shield illuminating apparatus 3, a light source driving control circuit (not shown) and a heat dissipating device 4.

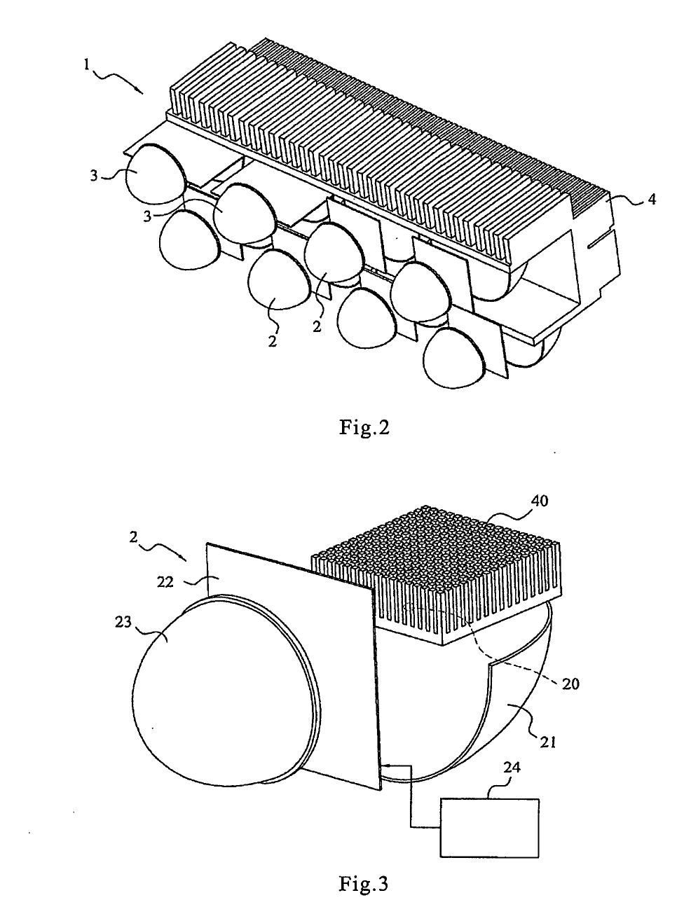

FIG. 3 is a schematic view of the electronic shield illuminating apparatus 2. The electronic shield illuminating apparatus 2 comprises a semiconductor light-emitting source 20, a reflector 21, an electronic shield 22, a projection lens 23, and a shield driving control circuit 24.

The semiconductor light-emitting source 20 can be a light-emitting diode (LED) or organic light-emitting diode (OLED), which is disposed to project the light downwardly, and also towards a reflecting surface of a corresponding reflector 21. The heat dissipating device 4 has a heat dissipating unit 40 provided on the upper portion of the semiconductor light-emitting source 20, to dissipate the heat generated by the semiconductor light-emitting source 20. Furthermore, the semiconductor light-emitting source 20 is electrically connected to the light source driving control circuit (not shown), and its luminance is adjustable by the light source driving control circuit.

The reflector 21 is disposed at a lower portion of the semiconductor light-emitting source 20, with its reflecting surface facing the semiconductor light-emitting source 20, so as to reflect a portion of the light projected by the semiconductor light-emitting source 20.

The electronic shield 22 is plate-like, and is disposed in front of the semiconductor light-emitting source 20 and reflector 21, so as to generate different shield patterns to mask the light emitted by the semiconductor light-emitting source 20 and that reflected by the reflector 21. The primary surface of the electronic shield 22 is arranged to face the semiconductor light-emitting source 20 and the reflecting surface of the reflector 21. The electronic shield 22 can be realized by a liquid crystal display (LCD) or electrochromic device, and is controlled by the shield driving control circuit 24 in a wired or wireless manner. The electronic shield 22 preferably may reflect the light. Therefore, the light that does not penetrate the electronic shield 22 may be reflected back to the reflector 21, and is then reflected by the reflector 21 to the electronic shield 22. In this manner, the light can be reused, and thus the energy efficiency of the electronic shield light-emitting device 2 is enhanced.

The projection lens 23 is an optical lens, and is arranged in front of the electronic shield 22 to project the light passing through the electronic shield 22, so that the light is radiated along a predetermined direction or towards a predetermined area.

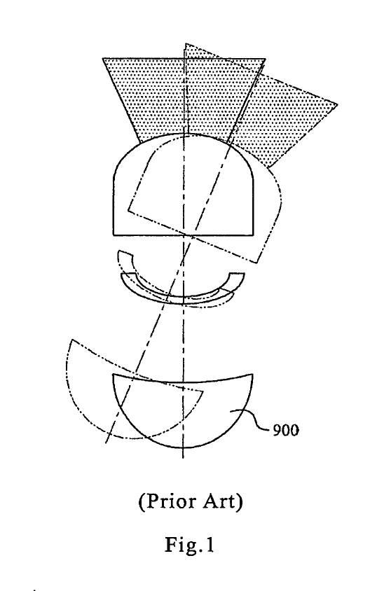

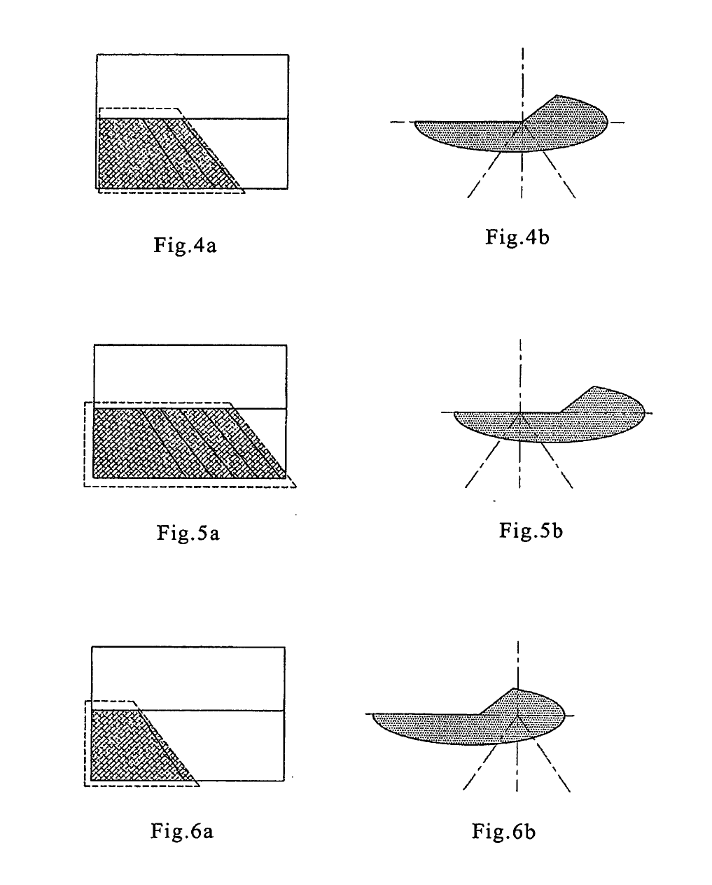

The shield driving control circuit 24 drives and controls the electronic shield 22 to generate different shield patterns in response to a signal information. Such signal information is a steering information of a traffic vehicle (for example, an automobile in the present embodiment). The steering information comprises information such as turning information (such as the rotation angles of the steering wheel or the turning angles of the front wheel), speed information, high/low beams on/off information, GPS information, screen wiper on/off information, and information provided by raindrops sensors, acceleration sensors, and horizontal sensors. For example, when the vehicle is in normal running mode (that is, travel linearly), the shield driving control circuit 24 controls the electronic shield 22 to generate the shield pattern as shown in FIG. 4a (the areas encompassed by imaginary lines), so that the resulting light pattern projected by the electronic shield illuminating apparatus 2 is formed as shown in FIG. 4b. When the vehicle turns right, the shield driving control circuit 24, based on the steering information of the vehicle, drives and controls the electronic shield 22 to generate the shield pattern as shown in FIG. 5a (the areas encompassed by imaginary lines), so that the resulting light pattern projected by the electronic shield illuminating apparatus 2 turns right as shown in FIG. 5b. When the vehicle turns left, the shield driving control circuit 24, based on the steering information of the vehicle, drives and controls the electronic shield 22 to generate the shield pattern as shown in FIG. 6a (the areas encompassed by imaginary lines), so that the resulting light pattern projected by the electronic shield illuminating apparatus 2 turns left as shown in FIG. 6b. Accordingly, the light patterns projected by the electronic shield illuminating apparatus 2 will be projected onto different locations in accordance with different shield patterns, and thereby the turning effect of the light patterns is achieved. Therefore, the electronic shield illuminating apparatus 2 can attain the effect of turning the projected light pattern by simply using the shield driving control circuit 24 to change the shield pattern generated by the electronic shield 22 without having to swivel or rotate. As compared with the conventional apparatus shown in FIG. 1, the electronic shield illuminating apparatus 2 according to the present invention is compact due to fewer components, and is faster in reaction.

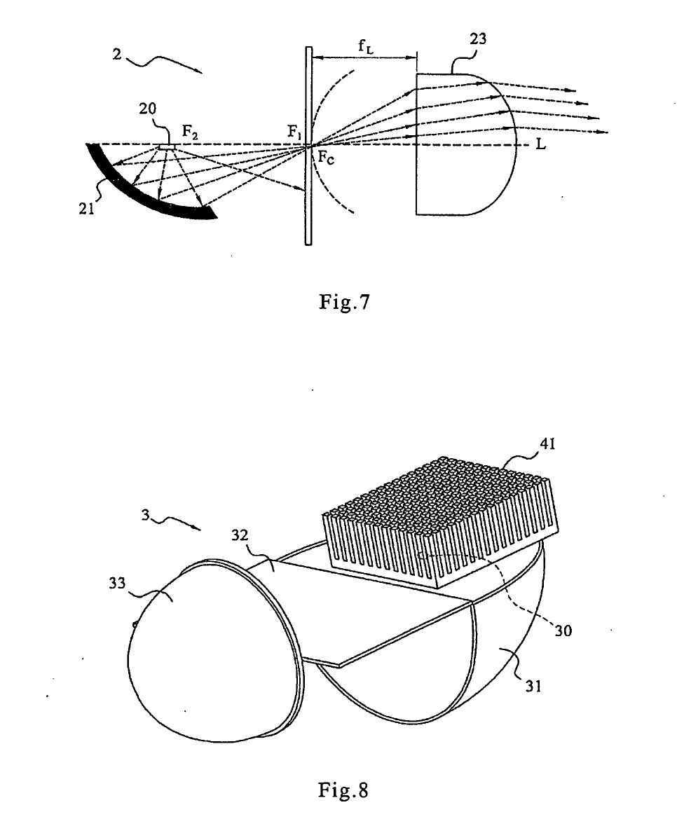

For explaining in detail the relative positions between the semiconductor light-emitting source 20, the reflector 21, the electronic shield 22 and the projection lens 23, reference is made to FIG. 7. FIG. 7 is a side view of the electronic shield illuminating apparatus 2. In the drawing, the shield driving control circuit is omitted for clarity, and the arrows indicate the travel paths of the light beams. The projection lens 23 includes an optical axis L and a theoretical focal point F_{C}. The reflector 21 includes a first theoretical focal point F₁ and a second theoretical focal point F₂. The first theoretical focal point F₁ substantially coincides with the theoretical focal point F_{C} of the projection lens 23, and a straight line formed by the first theoretical focal point F₁ and the second theoretical focal point F₂ substantially coincides, aligns, or is inclined with respect to the optical axis L of the projection lens 23 by an angle (ranging from 0 to 90 degrees). The semiconductor light-emitting source 20 is substantially disposed at the second theoretical focal point F₂, while the electronic shield 22 is substantially disposed at the theoretical focal point F_{C} of the projection lens 23.

Alternatively, the electronic shield illuminating apparatus 2 may also comprises a plurality of semiconductor light-emitting sources 20 and a plurality of corresponding reflectors 21. In this particular case, the first theoretical focal point F₁ of each reflector 21 is still substantially coincides with the theoretical focal point F_{C} of the projection lens 23, and a corresponding semiconductor light-emitting sources 20 is still provided at the second theoretical focal point F₂ of each reflector 21. The difference resides in that the straight line formed by the first theoretical focal point F₁ and the second theoretical focal point F₂ of each reflector 21 is inclined with respect to the optical axis L of the projection lens 23 by an angle. Such design is advantageous in that the longitudinal length of the electronic shield illuminating apparatus 2 is shortened, whereby the dimension of the illuminating apparatus 2 is reduced. Moreover, as the semiconductor light-emitting source 20 is increased in number, the luminance of the apparatus will increase accordingly.

FIG. 8 is a schematic drawing showing the structure of a thin plate shield illuminating apparatus 3. The thin plate shield illuminating apparatus 3 comprises a semiconductor light-emitting source 30, a reflector 31, a thin plate shield 32 and a projection lens 33.

The semiconductor light-emitting source 30 can be a light-emitting diode (LED) or organic light-emitting diode (OLED), which is disposed to project the light downwardly, and also towards a reflecting surface of a corresponding reflector 31. The heat dissipating device 4 has a heat dissipating unit 41 provided on the upper portion of the semiconductor light-emitting source 30, to dissipate the heat generated by the semiconductor light-emitting source 30. Furthermore, the semiconductor light-emitting source 30 is electrically connected to the light source driving control circuit, and its luminance is adjustable by the light source driving control circuit.

The reflector 31 is disposed at the lower portion of the semiconductor light-emitting source 30, with its reflecting surface facing the semiconductor light-emitting source 30, so as to reflect a portion of the light projected by the semiconductor light-emitting source 30.

The thin plate shield 32 is plate-like, and has a reflecting surface 320 impermeable to light for reflecting the portion of light emitted by the semiconductor light-emitting source 30 and the light reflected by the reflector 31. The reflecting surface 320 faces downwards.

The projection lens 33 which is a convex lens is disposed in front of the thin plate shield 32 for projecting the light passing through the thin plate shield 32, so that the light projects along a predetermined direction.

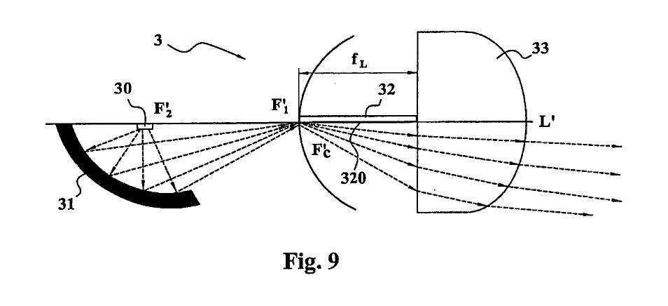

For explaining in detail the relative positions between the semiconductor light-emitting source 30, the reflector 31, the thin plate shield 32 and the projection lens 33, reference is made to FIG. 9. FIG. 9 is a side view of the thin plate shield illuminating apparatus 3. In the drawing, the directions of the arrows indicate the travel paths of the light beams. The projection lens 33 includes an optical axis L′ and a theoretical focal point F′_{C}. The reflector 31 includes a first theoretical focal point F′₁ and a second theoretical focal point F′₂. The first theoretical focal point F′₁ substantially coincides with the theoretical focal point F′_{C} of the projection lens 33, and a straight line formed by the first theoretical focal point F′₁ and the second theoretical focal point F′₂ substantially coincides, aligns, or is inclined with respect to the optical axis L′ of the projection lens 33 by an angle (ranging from 0 to 90 degrees). The semiconductor light-emitting source 30 is substantially disposed at the second theoretical focal point F′₂. The thin plate shield 32 is substantially disposed between the projection lens 33 and reflector 31, and its reflecting surface 320 passes through the first theoretical focal point F′1 of reflector 31. Moreover, the optical axis L′ of projection lens 33 passes through the reflecting surface 320 of the thin plate shield 32.

Likewise, the thin plate shield illuminating apparatus 3 may comprises a plurality of semiconductor light-emitting sources 30 and a plurality of corresponding reflectors 31. The arrangement of the thin plate shield illuminating apparatus 3 with respect to the plurality of semiconductor light-emitting sources and reflectors is similar to that of the electronic shield illuminating apparatus 2 with respect to the semiconductor light-emitting source 20 and reflectors 21, and thus the descriptions thereof are omitted.

Furthermore, the illuminating system 1 may comprise only the electronic shield illuminating apparatus 2, or the thin plate shield 3.

In view of the above, the illuminating system according to the present invention, by means of the electronic shield of the electronic shield illuminating apparatus, can attain the effect of turning the projected light pattern by simply using the shield driving control circuit to change the shield pattern generated by the electronic shield without having to swivel or rotate the illuminating system. As compared with the conventional apparatus shown in FIG. 1, the illuminating system according to the present invention is compact due to fewer components, and is faster in reaction time.

Although the present invention has been described with respect to preferred embodiments for a complete and clear disclosure, it will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents

What is claimed is:

1. An illuminating system having an electronic shield illuminating apparatus, the electronic shield illuminating apparatus comprising:
a first semiconductor light-emitting source disposed to project light downwardly;
a first reflector for reflecting a portion of the light emitted from the first semiconductor light-emitting source, the first reflector including a first reflecting surface facing the first semiconductor light-emitting source;
an electronic shield for generating different shield patterns for masking the light emitted by the first semiconductor light-emitting source, and the light reflected by the first reflector, the electronic shield having a main surface facing the first semiconductor light-emitting source and the first reflecting surface of the first reflector;
a shield driving control circuit for driving the electronic shield to generate different shield patterns in response to a signal information; and
a first projection lens for projecting the light passing through the electronic shield.

2. The illuminating system according to claim 1, wherein the signal information is a steering information of a vehicle comprising a turning information.

3. The illuminating system according to claim 2, wherein when the turning information indicates that the vehicle turns towards a direction, the driving control circuit controls the electronic shield to generate a predetermined shield pattern, so that the light passing through the electronic shield is deflected towards said direction.

4. The illuminating system according to claim 1, further comprising a thin plate shield illuminating apparatus, the thin plate shield illuminating apparatus comprising:
a second semiconductor light-emitting source;
a second reflector for reflecting a portion of light emitted by the second semiconductor light-emitting source, the second reflector including a second reflecting surface facing the second semiconductor light-emitting source;
a thin plate shield having a third reflecting surface impermeable to light for reflecting the light emitted by the second semiconductor light-emitting source and the light reflected by the second reflector; and
a second projection lens for projecting the light reflected by the thin plate shield and a portion of light emitted by the second semiconductor light-emitting source.

5. The illuminating system according to claim 4, wherein the semiconductor light-emitting source of the thin plate shield illuminating apparatus is disposed to project the light downwardly, and projects the light towards the second reflecting surface of the second reflector.

6. The illuminating system according to claim 4, wherein the third reflecting surface of the thin plate shield faces downwards.

7. The illuminating system according to claim 1, wherein the electronic shield is selected from either a liquid display device (LCD) or an electrochromic device.

8. The illuminating system according to claim 4, wherein the semiconductor light-emitting sources are selected from either a light-emitting diode (LED) or an organic light-emitting diode (OLED).

9. The illuminating system according to claim 4, further comprising a heat dissipating device located in proximity to the semiconductor light-emitting sources.

10. The illuminating system according to claim 1, wherein:
the projection lens comprises an optical axis and a theoretical focal point;
the first reflector comprises a first theoretical focal point and a second theoretical focal point, the first theoretical focal point coinciding with the theoretical focal point of the projection lens, and a straight line formed by the first theoretical focal point and the second theoretical focal point being inclined with respect to the optical axis of the projection lens by an angle;
the first semiconductor light-emitting source is substantially disposed at the second theoretical focal point;
the electronic shield is substantially disposed at the theoretical focal point of the projection lens.

11. The illuminating system according to claim 10, wherein in the angle ranges from 0 to 90 degrees.

12. A thin plate shield illuminating apparatus, comprising:
a semiconductor light-emitting source disposed to project light downwardly;
a reflector for reflecting a portion of the light emitted from the semiconductor light-emitting source, the reflector including a reflecting surface facing the semiconductor light-emitting source;
a thin plate shield having a reflecting surface impermeable to light for reflecting the light emitted by the semiconductor light-emitting source and the light reflected by the reflector; and
a projection lens for projecting the light reflected by the thin plate shield and a portion of light emitted by the semiconductor light-emitting source.

13. The thin plate shield illuminating apparatus according to claim 12, wherein the reflecting surface of the thin plate shield faces downwards.

14. The thin plate shield illuminating apparatus according to claim 12, wherein:
the projection lens comprises an optical axis and a theoretical focal point;
the reflector comprises a first theoretical focal point and a second theoretical focal point, the first theoretical focal point substantially coinciding with the theoretical focal point of the projection lens, and a straight line formed by the first theoretical focal point and the second theoretical focal point being inclined with respect to the optical axis of the projection lens by an angle;
the semiconductor light-emitting source is substantially disposed at the second theoretical focal point of the reflector;
the thin plate shield is disposed between the projection lens and the reflector.

15. The thin plate shield illuminating apparatus according to claim 14, wherein the angle ranges from 0 to 90 degrees.
